(19) United States
(12) Patent Application Publication
(10) Pub. No.: US 2025/0111286 A1
(43) Pub. Date: Apr. 3, 2025

(54) SYSTEMS AND METHODS FOR MACHINE LEARNING OPERATIONS

(71) Applicant: Fidelity Information Services, LLC, Jacksonville, FL (US)

(72) Inventors: Ranadhir GHOSH, St Johns, FL (US); Gautam KUMAR, Bengaluru (IN); John PLATAIS, Menomonee Falls, WI (US)

(21) Appl. No.: 18/962,598

(22) Filed: Nov. 27, 2024

Related U.S. Application Data
(63) Continuation-in-part of application No. 18/478,106, filed on Sep. 29, 2023.

(51) Int. Cl. G06N 20/00

(52) U.S. Cl. CPC G06N 20/00

(57) ABSTRACT

A computer-implemented method for automatically retraining a machine learning system, the method including: receiving a plurality of data objects, the plurality of data objects corresponding to information technology event data and representing an occurrence of an event; processing the plurality of data objects; evaluating whether to perform hyperparameter tuning of a first model of a first machine learning system based on characteristics of the plurality of data objects; training the first model of the first machine learning system based on the processed plurality of data objects; storing a retrained model of the first machine learning system.

### CROSS-REFERENCE TO RELATED APPLICATION(S)

This patent application is a continuation-in-part of and claims the benefit of priority to U.S. application Ser. No. 18/478,106, filed on Sep. 29, 2023, the entirety of which is incorporated herein by reference.

### TECHNICAL FIELD

Various embodiments of the present disclosure relate generally to information technology (IT) management systems and, more particularly, to system and methods for customized machine learning operations (MLOps).

### BACKGROUND

In computing systems, for example computing systems that perform financial services and electronic payment transactions, programing changes may occur. For example, software may be updated. Changes in the system may lead to incidents, defects, issues, bugs or problems (collectively referred to as incidents) within the system. These incidents may occur at the time of a software change or at a later time. These incidents may be costly for the company as users may not be able to use the services, and due to resources expended by the company to resolve the incidents.

These incidents in the system may need to be examined and resolved in order to have the software services perform correctly. Time may be spent by, for example, incident resolution teams, determining what issues arose within the software services. The faster an incident may be resolved, the less potential costs a company may incur. Thus, promptly identifying and fixing such incidents (e.g., writing new code or updating deployed code) may be important to a company. One or more machine learning systems may be implemented to analyze incidents or other events in a system.

A system may incorporate one or more machine learning systems. Orchestrating, managing, and retraining one or more machine learning models may be challenging and complex. The present disclosure is directed to addressing this and other drawbacks to managing machine learning operations.

The background description provided herein is for the purpose of generally presenting context of the disclosure. Unless otherwise indicated herein, the materials described in this section are not prior art to the claims in this application and are not admitted to be prior art, or suggestions of the prior art.

### SUMMARY OF THE DISCLOSURE

In some aspects, the techniques described herein relate to a method for automatically implementing a machine learning system, the method including: receiving a plurality of data objects, the plurality of data objects corresponding to information technology event data and representing an occurrence of an event; processing the plurality of data objects; evaluating whether to perform hyperparameter tuning of a first model of a first machine learning system based on characteristics of the plurality of data objects; training the first model of the first machine learning system based on the processed plurality of data objects to determine a retrained model, wherein the training the first model further includes: comparing performance of the retrained model with a previous model of the first machine learning system to ensure the retrained model has improved model performance as compared to the previous model; and storing the retrained model of the first machine learning system.

In some aspects, the techniques described herein relate to a method, wherein the plurality of data objects is received from a plurality of data sources.

In some aspects, the techniques described herein relate to a method, wherein the processing the plurality of data objects further includes: applying one or more of a lower casing, tokenization, punctuation mark removal, stop word removal, stemming, and/or lemmatization algorithms.

In some aspects, the techniques described herein relate to a method, wherein the processing the plurality of data objects further includes: removing outlier and inconsistent data from the plurality of data objects; and determining corresponding metadata for missing data from the plurality of data objects, wherein the corresponding metadata ensures the plurality of data objects have a compatible format with first model input requirements.

In some aspects, the techniques described herein relate to a method, wherein the machine learning system is configured to analyze information technology data.

In some aspects, the techniques described herein relate to a method, wherein the first model of the first machine learning system corresponds to a latest version of the first machine learning system, the first machine learning system having previously been trained.

In some aspects, the techniques described herein relate to a method, wherein the evaluating whether to perform hyperparameter tuning based on characteristics of the plurality of data objects, further includes: applying a groupsearch function to optimize one or more hyperparameters of the first model, wherein the one or more hyperparameters includes a learning rate.

In some aspects, the techniques described herein relate to a method, wherein the training the first model of the first machine learning system further includes: inserting the processed plurality of data objects into the first model of the machine learning system; calculating a loss associated for the first model; computing gradients of the loss; and updating parameters of the first model utilizing an optimization algorithm that incorporates the gradient of the loss.

In some aspects, the techniques described herein relate to a method, wherein the storing the retrained model of the first machine learning system includes assigning an updated name, timestamp, and tag of the retrained model to storage.

In some aspects, the techniques described herein relate to a method, further including: accessing the retrained model; and utilizing the retrained model to process information technology event data to identify correlation, similarity, or a root cause an information technology event.

In some aspects, the techniques described herein relate to a system for automatically implementing a machine learning system, the system including: a memory having processor-readable instructions stored therein; and at least one processor configured to access the memory and execute the processor-readable instructions to perform operations including: receiving a plurality of data objects, the plurality of data objects corresponding to information technology event data and representing an occurrence of an event; processing the plurality of data objects; evaluating whether to perform hyperparameter tuning of a first model of a first machine learning system based on characteristics of the plurality of data objects; training the first model of the first machine learning system based on the processed plurality of data objects to determine a retrained model, wherein the training the first model further includes: comparing performance of the retrained model with a previous model of the first machine learning system to ensure the retrained model has improved model performance as compared to the previous model; and storing the retrained model of the first machine learning system.

In some aspects, the techniques described herein relate to a system, wherein the plurality of data objects is received from a plurality of data sources.

In some aspects, the techniques described herein relate to a system, wherein the processing the plurality of data objects further includes: applying one or more of a lower casing, tokenization, punctuation mark removal, stop word removal, stemming, and/or lemmatization algorithms.

In some aspects, the techniques described herein relate to a system, wherein the processing the plurality of data objects further includes: removing outlier and inconsistent data from the plurality of data objects; and determining corresponding metadata for missing data from the plurality of data objects, wherein the corresponding metadata ensures the plurality of data objects have a compatible format with first model input requirements.

In some aspects, the techniques described herein relate to a system, wherein the machine learning system is configured to analyze information technology data.

In some aspects, the techniques described herein relate to a system, wherein the first model corresponds to a latest version of the first machine learning system, the first machine learning system having previously been trained.

In some aspects, the techniques described herein relate to a non-transitory computer readable medium configured to store processor-readable instructions which, when executed by at least one processor, cause the at least one processor to perform operations including: receiving a plurality of data objects, the plurality of data objects corresponding to information technology event data and representing an occurrence of an event; processing the plurality of data objects; evaluating whether to perform hyperparameter tuning of a first model of a first machine learning system based on characteristics of the plurality of data objects; training the first model of the first machine learning system based on the processed plurality of data objects to determine a retrained model, wherein training the first model further includes: comparing performance of the retrained model with a previous model of the first machine learning system to ensure the retrained model has improved model performance as compared to the previous model; and storing the retrained model of the first machine learning system.

In some aspects, the techniques described herein relate to a non-transitory computer readable medium, wherein the plurality of data objects is received from a plurality of data sources.

In some aspects, the techniques described herein relate to a non-transitory computer readable medium, wherein the processing the plurality of data objects further includes: applying one or more of a lower casing, tokenization, punctuation mark removal, stop word removal, stemming, and/or lemmatization algorithms.

In some aspects, the techniques described herein relate to a non-transitory computer readable medium, wherein the processing the plurality of data objects further includes: removing outlier and inconsistent data from the plurality of data objects; and determining corresponding metadata for missing data from the plurality of data objects, wherein the corresponding metadata ensures the plurality of data objects have a compatible format with first model input requirements.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary system overview for a data pipeline for an artificial intelligence module to predict and troubleshoot incidents in a system, according to one or more embodiments.

FIG. 2 depicts a flowchart of a method for continuous integration and deployment of application code, according to one or more embodiments.

FIG. 3 depicts a diagram of the method for continuous integration and deployment of application code, according to one or more embodiments.

FIG. 4 depicts an exemplary user interface for a model retraining pipeline, according to one or more embodiments.

FIG. 5 depicts an exemplary flowchart of a method for automatically retraining a machine learning system, according to one or more embodiments.

FIG. 6 depicts a flowchart of a method for model repository versioning and serving, according to one or more embodiments.

FIG. 7 illustrates a computer system for executing the techniques described herein, according to one or more embodiments of the present disclosure.

### DETAILED DESCRIPTION OF EMBODIMENTS

Various embodiments of the present disclosure relate generally to information technology (IT) management systems and, more particularly, to system and methods for customized machine learning operations (MLOps).

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment, and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Software companies have been struggling to avoid outages from incidents that may be caused by upgrading software or hardware components, or changing a member of a team, for example. The system described herein may be configured to analyze and/or process event data for an Information Technology (IT) system. The system described herein may, for example receive a stream of event data over periods of time and/or set of batch data. This event data may further be described as IT event data. Event data may include, but is not limited: (1) an incident, (2) an alert, (3) change data, (4) a problem, and/or (5) an anomaly.

An incident may be an occurrence that can disrupt or cause a loss of operation, services, or functions of a system. Incidents may be manually reported by customers or personnel, may be automatically logged by internal systems, or may be captured in other ways. An incident may occur from factors such as hardware failure, software failure, software bugs, human error, and/or cyber attacks. Deploying, refactoring, or releasing software code may, for example, cause an incident. An incident may be detected during, for example, an outage or a performance change. An incident may include characteristics, where an incident characteristic may refer to the quality or traits associated with an incident. For example, incident characteristics may include, but are not limited to, the severity of an incident, the urgency of an incident, the complexity of an incident, the scope of an incident, the cause of an incident, and/or what configurable item corresponds to the incident (e.g., what systems/platforms/products etc. are affected by the incident), how it is described in freeform text, what business segment is effected, what category/subcategory is affected, and/or what assigned group is the incident.

An alert may refer to a notification that informs a system or user of an event. An alert may include a collection of events representing a deviation from normal behavior for a system. For example, an alert may include metadata including a short field description that includes free from text fields (e.g., a summary of the alert), first occurrences, time stamps, an alert key, etc. Understanding the different types of alerts within a system from various perspectives may assist in resolving incidents.

Change data may refer to information that describes a modification made to data within a system or database. Change data may track the changes that occur over one or more periods of time. Problem data may refer to any data that causes issues or impedes a systems normal operations. Anomaly data may refer to data that indicates a deviation of a system from a standard or normal operation.

The event data may further include entities effected by the event and their respective relationships. Event data may be associated with one or more configurable items (CIs). A configurable item (CI) may refer a component of a system that can be identified as a self-contained unit for purposes of change control and identification. For example, a particular application, service, particular product, server, may be defined by a CI.

Software companies have struggled to have systems capable of analyzing IT event data. For example, a system may receive fast amounts of IT event data. The system may process and analyze the received IT event data in a variety of ways. For example, the system may implement multiple machine learning systems to perform a variety of analysis. It may be challenging to orchestrate and manage machine learning workflows at scale. Further, creating a Machine Learning Operations (MLOps) framework that may enhance model deploy, monitoring, and maintenance of the machine learning systems may be challenging.

Conventional systems may include manual product or application deployment. A manual process may be where an application team builds an application and deploys the application to the production environment by copying the build and copying the required configurations. This may be time consuming and inefficient.

Conventional systems may include manual retraining of and one or more machine learning models. Evolving data sources and changing patterns over time can lead to data drift, affecting the quality of training data. Managing multiple model versions and deploying updates seamlessly may be a complex and time consuming process.

Conventional systems may request manual versioning within a model repository. A large number of model version can accumulate, leading to internal confusion as to which model to incorporate within a system. Models may depend on specific versions of libraries, making it challenging to replicate the environment. Ensuring collaboration and visibility across teams, especially when models are updated by multiple contributors may be challenging.

Conventional systems may struggle to meet real-time requirements for model inference, especially when dealing with large datasets or complex algorithms. Scaling Flask APIs may handle increased loads, particularly when dealing with resource-intensive machine learning models.

One or more embodiments may be configured to provide strategic customization of MLOps tailored for the large enterprise Artificial Intelligence for IT Operations (AIOps) solutions. The system may address the unique challenges and requirements associated with orchestrating and managing machine learning workflows at scale. The system may be configured to provide customization that involves optimizing the integration of machine learning models into operational processes, ensuring seamless collaboration between data scientists and IT operations teams. The system may include a MLOps framework to enhance model deployment, monitoring, and maintenance in the dynamic landscape of enterprise AIOps. By customizing MLOps practices, a user of the systems and methods described herein can efficiently scale AI-driven solutions, improve operational efficiency, and derive maximum value from sophisticated machine learning algorithms in large-scale IT environments.

One or more embodiments may allow for various types of data processing in order to identify correlations, similarity, and root causes, and recommend a corrective action based on received data as well as user feedback mechanisms. One or more embodiments may be extended to clients and users of services and software with applications that are connected to the systems and methods described herein.

One or more embodiments of the systems and methods described herein may be configured to produce Artificial Intelligence (AI)/machine learning (ML) models. The system may configured to implement the one or more AI/ML models. In some embodiments, the system has three main functions: (1) provide software development code to automate the Continuous Integration/Continuous Deployment (CI/CD) pipeline; (2) provide retraining of the one or more AI/ML models; and (3) provide model repository versioning and severing.

Advantageously, the systems and methods described herein may automate a process for a CI/CD pipeline in conjunction with an automated MLOps framework. This may increase the ability for a system to deploy, monitor, maintain, and retrain multiple machine learning models at once for a system.

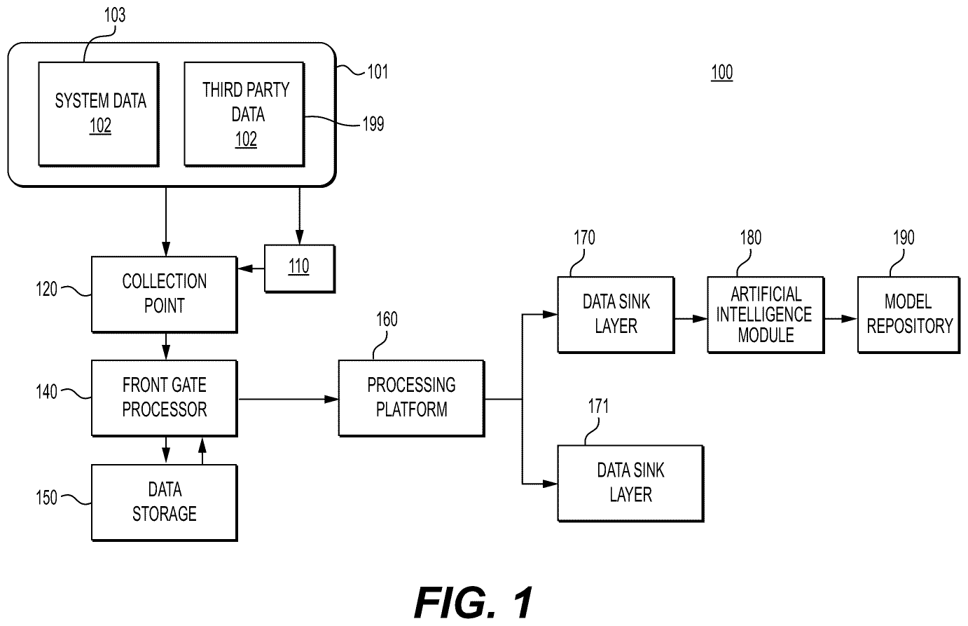

FIG. 1 depicts an exemplary system overview for a data pipeline for an artificial intelligence module to predict and troubleshoot incidents in a system, according to one or more embodiments. For example, the data pipeline system 100 may aggregate and send IT event data to an artificial intelligence module 180, wherein the artificial intelligence module 180 is configured to aggregate and map incident characteristics into daily incident profiles using feature engineering and/or multiple level clustering. The data pipeline system 100 may be a platform with multiple interconnected components. The data pipeline system 100 may include one or more servers, intelligent networking devices, computing devices, components, and corresponding software for aggregating and processing data.

As shown in FIG. 1, a data pipeline system 100 may include a data source 101, a collection point 120, a secondary collection point 110, a front gate processor 140, data storage 150, a processing platform 160, a data sink layer 170, a data sink layer 171, an artificial intelligence module 180, and a model repository 190.

The data source 101 may include in-house data 103 and third party data 199. The in-house data 103 may be a data source directly linked to the data pipeline system 100. Third party data 199 may be a data source connected to the data pipeline system 100 externally as will be described in greater detail below.

Both the in-house data 103 and third party data 199 of the data source 101 may include incident data 102. Incident data 102 may include incident reports with information for each incident provided with one or more of an incident number, closed date/time, category, close code, close note, long description, short description, root cause, or assignment group. Incident data 102 may include incident reports with information for each incident provided with one or more of an issue key, description, summary, label, issue type, fix version, environment, author, or comments. Incident data 102 may include incident reports with information for each incident provided with one or more of a file name, script name, script type, script description, display identifier, message, committer type, committer link, properties, file changes, or branch information. Incident data 102 may include one or more of real-time data, market data, performance data, historical data, utilization data, infrastructure data, or security data. These are merely examples of information that may be used as data, and the disclosure is not limited to these examples. The data source may further output IT event data including, but not limited alert data, change data, problem data, and anomaly data along with corresponding metadata associated with the IT event data.

Incident data 102 may be generated automatically by monitoring tools that generate alerts and incident data to provide notification of high-risk actions, failures in IT environment, and may be generated as tickets. Incident data may include metadata, such as, for example, text fields, identifying codes, and time stamps.

The in-house data 103 may be stored in a relational database including an incident table. The incident table may be provided as one or more tables, and may include, for example, one or more of problems, tasks, risk conditions, incidents, or changes. The relational database may be stored in a cloud. The relational database may be connected through encryption to a gateway. The relational database may send and receive periodic updates to and from the cloud. The cloud may be a remote cloud service, a local service, or any combination thereof. The cloud may include a gateway connected to a processing API configured to transfer data to the collection point 120 or a secondary collection point 110. The incident table may include incident data 102.

Data pipeline system 100 may include third party data 199 generated and maintained by third party data producers. Third party data producers may produce incident data 102 from Internet of Things (IoT) devices, desktop-level devices, and sensors. Third party data producers may include but are not limited to Tryambak, Appneta, Oracle, Prognosis, ThousandEyes, Zabbix, ServiceNow, Density, Dyatrace, etc. The incident data 102 may include metadata indicating that the data belongs to a particular client or associated system.

The data pipeline system 100 may include a secondary collection point 110 to collect and pre-process incident data 102 from the data source 101. The secondary collection point 110 may be utilized prior to transferring data to a collection point 120. The secondary collection point 110 point may, for example, be an Apache MiNiFi software. In one example, the secondary collection point 110 may run on a microprocessor for a third party data producer. Each third party data producer may have an instance of the secondary collection point 110 running on a microprocessor. The secondary collection point 110 may support data formats including but not limited to JSON, CSV, Avro, ORC, HTML, XML, and Parquet. The secondary collection point 110 may encrypt incident data 102 collected from the third party data producers. The secondary collection point 110 may encrypt incident data, including, but not limited to, Mutual Authentication Transport Layer Security (mTLS), HTTPs, SSH, PGP, IPsec, and SSL. The secondary collection point 110 may perform initial transformation or processing of incident data 102. The secondary collection point 110 may be configured to collect data from a variety of protocols, have data provenance generated immediately, apply transformations and encryptions on the data, and prioritize data.

The data pipeline system 100 may include a collection point 120. The collection point 120 may be a system configured to provide a secure framework for routing, transforming, and delivering data across from the data source 101 to downstream processing devices (e.g., the front gate processor 140). The collection point 120 may, for example, be a software such as Apache NiFi. The collection point 120 may receive raw data and the data's corresponding fields such as the source name and ingestion time. The collection point 120 may run on a Linux Virtual Machine (VM) on a remote server. The collection point 120 may include one or more nodes. For example, the collection point 120 may receive incident data 102 directly from the data source 101. In another example, the collection point 120 may receive incident data 102 from the secondary collection point 110. The secondary collection point 110 may transfer the incident data 102 to the collection point 120 using, for example, Site-to-Site protocol. The collection point 120 may include a flow algorithm. The flow algorithm may connect different processors, as described herein, to transfer and modify data from one source to another. For each third party data producer, the collection point 120 may have a separate flow algorithm. Each flow algorithm may include a processing group. The processing group may include one or more processors. The one or more processors may, for example, fetch incident data 102 from the relational database. The one or more processors may utilize the processing API of the in-house data 103 to make an API call to a relational database to fetch incident data 102 from the incident table. The one or more processors may further transfer incident data 102 to a destination system such as a front gate processor 140. The collection point 120 may encrypt data through HTTPS, Mutual Authentication Transport Layer Security (mTLS), SSH, PGP, IPsec, and/or SSL, etc. The collection point 120 may support data formats including but not limited to JSON, CSV, Avro, ORC, HTML, XML, and Parquet. The collection point 120 may be configured to write messages to clusters of a front gate processor 140 and communication with the front gate processor 140.

The data pipeline system 100 may include a distributed event streaming platform such as a front gate processor 140. The front gate processor 140 may be connected to and configured to receive data from the collection point 120. The front gate processor 140 may be implemented in an Apache Kafka cluster software system. The front gate processor 140 may include one or more message brokers and corresponding nodes. The message broker may, for example, be an intermediary computer program module that translates a message from the formal messaging protocol of the sender to the formal messaging protocol of the receiver. The message broker may be on a single node in the front gate processor 140. A message broker of the front gate processor 140 may run on a virtual machine (VM) on a remote server. The collection point 120 may send the incident data 102 to one or more of the message brokers of the front gate processor 140. Each message broker may include a topic to store similar categories of incident data 102. A topic may be an ordered log of events. Each topic may include one or more sub-topics. For example, one sub-topic may store incident data 102 relating to network problems and another topic may store incident data 102 related to security breaches from third party data producers. Each topic may further include one or more partitions. The partitions may be a systematic way of breaking the one topic log file into many logs, each of which can be hosted on a separate server. Each partition may be configured to store as much as a byte of incident data 102. Each topic may be partitioned evenly between one or more message brokers to achieve load balancing and scalability. The front gate processor 140 may be configured to categorize the received data into a plurality of client categories, thereby forming a plurality of datasets associated with the respective client categories. These datasets may be stored separately within the storage device as described in greater detail below. The front gate processor 140 may further transfer data to storage and to processors for further processing.

For example, the front gate processor 140 may be configured to assign particular data to a corresponding topic. Alert sources may be assigned to an alert topic, and incident data may be assigned to an incident topic. Change data may be assigned to a change topic. Problem data may be assigned to a problem topic.

The data pipeline system 100 may include a software framework for data storage 150. The data storage 150 may be configured for long term storage and distributed processing. The data storage 150 may be implemented using, for example, Apache Hadoop. The data storage 150 may store incident data 102 transferred from the front gate processor 140. In particular, data storage 150 may be utilized for distributed processing of incident data 102, and Hadoop distributed file system (HDFS) within the data storage may be used for organizing communications and storage of incident data 102. For example, the HDFS may replicate any node from the front gate processor 140. This replication may protect against hardware or software failures of the front gate processor 140. The processing may be performed in parallel on multiple servers simultaneously.

The data storage 150 may include an HDFS that is configured to receive the metadata (e.g., incident data). The data storage 150 may further process the data utilizing a MapReduce algorithm. The MapReduce algorithm may allow for parallel processing of large data sets. The data storage 150 may further aggregate and store the data utilizing Yet Another Resource Negotiation (YARN). YARN may be used for cluster resource management and planning tasks of the stored data. For example, a cluster computing framework, such as the processing platform 160, may be arranged to further utilize the HDFS of the data storage 150.

For example, if the data source 101 stops providing data, the processing platform 160 may be configured to retrieve data from the data storage 150 either directly or through the front gate processor 140. The data storage 150 may allow for the distributed processing of large data sets across clusters of computers using programming models. The data storage 150 may include a master node and an HDFS for distributing processing across a plurality of data nodes. The master node may store metadata such as the number of blocks and their locations. The main node may maintain the file system namespace and regulate client access to said files. The main node may comprise files and directories and perform file system executions such as naming, closing, and opening files. The data storage 150 may scale up from a single server to thousands of machines, each offering local computation and storage. The data storage 150 may be configured to store the incident data in an unstructured, semi-structured, or structured form. In one example, the plurality of datasets associated with the respective client categories may be stored separately. The master node may store the metadata such as the separate dataset locations.

The data pipeline system 100 may include a real-time processing framework, e.g., a processing platform 160. In one example, the processing platform 160 may be a distributed dataflow engine that does not have its own storage layer. For example, this may be the software platform Apache Flink. In another example, the software platform Apache Spark may be utilized. The processing platform 160 may support stream processing and batch processing. Stream processing may be a type of data processing that performs continuous, real-time analysis of received data. Batch processing may involve receiving discrete data sets processed in batches. The processing platform 160 may include one or more nodes. The processing platform 160 may aggregate incident data 102 (e.g., incident data 102 that has been processed by the front gate processor 140) received from the front gate processor 140. The processing platform 160 may include one or more operators to transform and process the received data. For example, a single operator may filter the incident data 102 and then connect to another operator to perform further data transformation. The processing platform 160 may process incident data 102 in parallel. A single operator may be on a single node within the processing platform 160. The processing platform 160 may be configured to filter and only send particular processed data to a particular data sink layer. For example, depending on the data source of the incident data 102 (e.g., whether the data is in-house data 103 or third party data 199), the data may be transferred to a separate data sink layer (e.g., the data sink layer 170, or data sink layer 171). Further, additional data that is not required at downstream modules (e.g., at the artificial intelligence module 180) may be filtered and excluded prior to transferring the data to a data sink layer.

The processing platform 160 may perform three functions. First, the processing platform 160 may perform data validation. The data's value, structure, and/or format may be matched with the schema of the destination (e.g., the data sink layer 170). Second, the processing platform 160 may perform a data transformation. For example, a source field, target field, function, and parameter from the data may be extracted. Based upon the extracted function of the data, a particular transformation may be applied. The transformation may reformat the data for a particular use downstream. A user may be able to select a particular format for downstream use. Third, the processing platform 160 may perform data routing. For example, the processing platform 160 may select the shortest and/or most reliable path to send data to a respective sink layer (e.g., the data sink layer 170 and/or sink layer 171).

In one example, the processing platform 160 may be configured to transfer particular sets of data to a data sink layer. For example, the processing platform 160 may receive input variables for a particular artificial intelligence module 180. The processing platform 160 may then filter the data received from the front gate processor 140 and only transfer data related to the input variables of the artificial intelligence module 180 to a data sink layer.

The data pipeline system 100 may include one or more data sink layers (e.g., the data sink layer 170 and data sink layer 171). Incident data 102 processed from processing platform 160 may be transmitted to and stored in the data sink layer 170. In one example, the data sink layer 171 may be stored externally on a particular client's server. The data sink layer 170 and data sink layer 171 may be implemented using a software such as, but not limited to, PostgreSQL, HIVE, Kafka, OpenSearch, and Neo4j. The data sink layer 170 may receive in-house data 103, which have been processed and received from the processing platform 160. The data sink layer 171 may receive third party data 199, which have been processed and received from the processing platform 160. The data sink layers may be configured to transfer incident data 102 to an artificial intelligence module 180. The data sink layers may be data lakes, data warehouses, or cloud storage systems. Each data sink layer may be configured to store incident data 102 in both a structured or unstructured format. The data sink layer 170 may store incident data 102 with several different formats. For example, the data sink layer 170 may support data formats such as JavaScript Objection Notation (JSON), comma-separated value (CSV), Avro, Optimized Row Columnar (ORC), Hypertext Markup Language (HTML), Extensible Markup Language (XML), or Parquet, etc. The data sink layer (e.g., the data sink layer 170 or data sink layer 171), may be accessed by one or more separate components. For example, the data sink layer may be accessed by a Non-structured Query language (“NoSQL”) database management system (e.g., a Cassandra cluster), a graph database management system (e.g., Neo4j cluster), further processing programs (e.g., Kafka+Flink programs), and a relation database management system (e.g., PostgresSQL cluster). Further processing may then be performed prior to the processed data being received by an artificial intelligence module 180.

The data pipeline system 100 may include an artificial intelligence module 180. The artificial intelligence module 180 may include a machine-learning component (e.g., one or more machine learning models). The artificial intelligence module 180 may use the received data in order to train and/or use a machine learning model. The machine learning model may be, for example, a neural network. Nonetheless, it should be noted that other machine learning techniques and frameworks may be used by the artificial intelligence module 180 to perform the methods contemplated by the present disclosure. For example, the systems and methods may be realized using other types of supervised and unsupervised machine learning techniques such as regression problems, random forest, cluster algorithms, principal component analysis (PCA), reinforcement learning, or a combination thereof. The artificial intelligence module 180 may be configured to extract and receive data from the data sink layer 170.

The data pipeline system 100 may include a model repository 190. The model repository 190 may be configured to store one or more machine learning models (e.g., from artificial intelligence module 180). In some examples, the model repository 190 may be located in the data storage 150. The model repository 190 may include a versioning component and a serving component. The versioning component may be configured to log versions of a machine learning model as models are retrained. The versioning component may save associated metadata related to a version of a model such as an updated name, timestamp, and tag of the retrained model. The serving component of the model repository 190 may be the component configured to load a particular version of a machine learning system to a user. The serving component may ensure latest versions of a machine learning model are loaded when users request access to the model and may further be configured to execute predict required functions with the loaded model.

In certain embodiments, the system (e.g., the data pipeline system 100) may be configured to set up a CI/CD pipeline for application code involving a series of automate steps. This may ensure code quality and streamline the deployment process of a ML/AI model (e.g., for the one or more machine learning models of the artificial intelligence module 180). For example, the CI/CD pipeline may include automated processes that allows for the merging of code/ML models into a shared repository, and to automatically build, test, and deploy the new machine learning models.

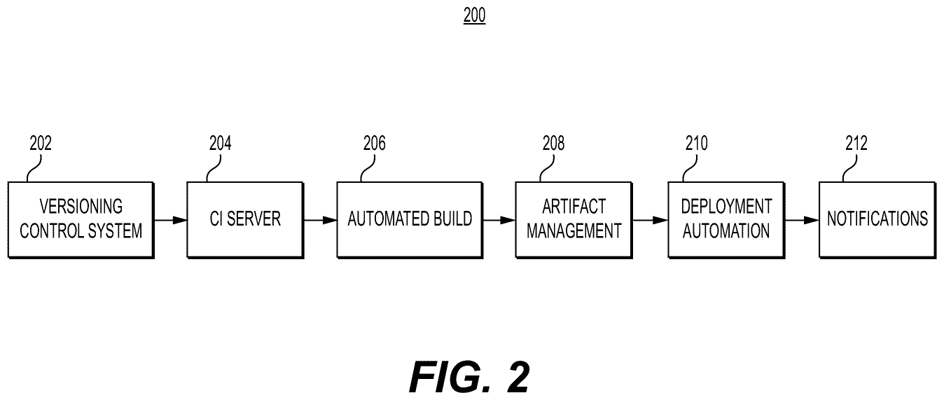

FIG. 2 depicts a flowchart 200 of a method for continuous integration and deployment of application code, according to one or more embodiments. The method described in FIG. 2 may be implemented by the data pipeline system 100 of FIG.

At step 202, a versioning control system (VCS) (e.g., MLflow) may be selected to manage the source code of a respective MI/AI model. The versioning control system may be located in a host repository (e.g., located in the data storage 150 of FIG. 1). For example, a host repository may be on a platform, including, but not limited to Bibucket, Github, or Gitlab. The VCS may be a tool configured to track changes to one or more ML model's files and artifacts over time. Artifact may refer to any output or byproduct of a retrained machine learning model. The VCS may allow for different hyperparameters to be adjusted during training and updating of a machine learning model.

At step 204, a continuous integration (CI) server may be chosen (e.g., Jenkins). The CI server selected may be configured to monitor the respective VCS for changes. The CI server may be located in the data storage 150 of FIG. 1. For example, the CI server may monitor the version control system for changes my implementing webhooks or polling. When applying webhooks, a callback URL may be provided to the VCS and when a change occurs in the CS, an automatic notification may occur to start a build pipeline. Applying polling my include the CI server performing periodical checks of the VCS searching for changes at set time intervals.

At step 206, an automated build may be occur. For example, the automated build may occur when the CI server receives a notification (e.g., through webhook or pulling) that a change to the version control system has occurred. The system may be configured to define a build script to compile/build a respective application. The system may automatically trigger the build on each commit or pull request. The build may retrieve the latest version of code from the VCS, and compile or package the code into a deployable artifact (e.g., as a build artifact file).

At step 208, artifact management may be performed. For example, the system may store build artifact files in an artifact repository (e.g., Nexus, JFrog Artifactory). For example, the build artifact files may be stored in the VCS. The may allow for different version of artifacts to be tracked. Storage of the artifact files may ensure availability and integrity of the artifacts throughout the deployment process.

At step 210, the system may be configured to deploy. For example, the system may define deployment scripts or configuration (e.g., Ansible, terraform) for a target environment. This means that the respective artifact files may be copied and installed onto a specific system or server where they can be executed or used (e.g., by a user accessing the artificial intelligence module 180). This may be the serving component of the model repository 190. The system may be configured to automate the deployment process to staging or production environments. This means that the scripts or configuration files (e.g., of the artifact files) may be packaged (e.g., in a ZIP file, JAR file, or Docker image), deployed to a production server (e.g., a sever where the new artifact may be accessed and used), installed within the respective production server, and have any necessary configuration setting applied to the artifact files to configure them to the specific production servers.

At step 212, the system may be configured to set up notifications to alert one or more systems, servers, or individuals about build features, successful deployments, or other important events. For example, automatic notification may be issued to one or more users whenever step 210 is complete for a particular ML model.

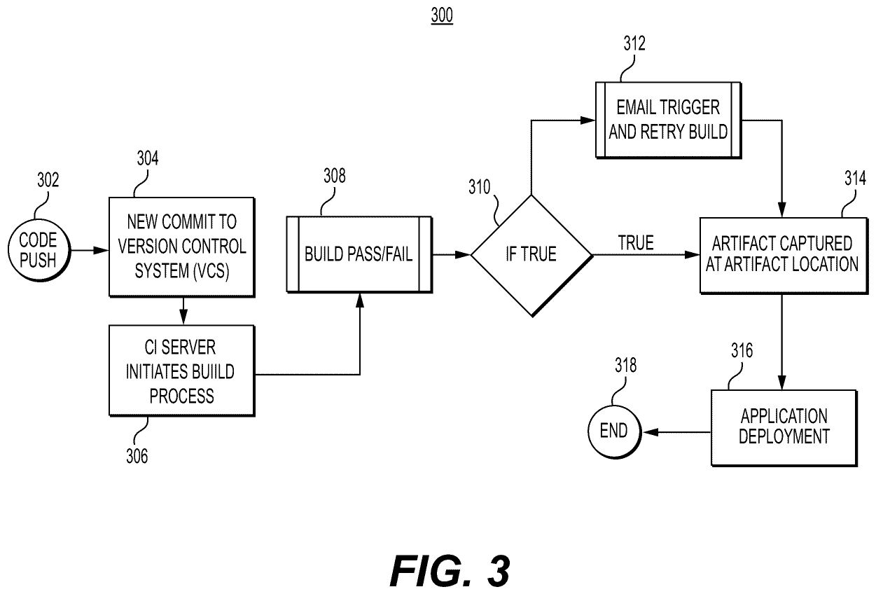

FIG. 3 depicts a diagram 300 of the method for continuous integration and deployment of application code, according to one or more embodiments. The diagram 300 may display an example of how the method of flowchart 200 may be performed. The method described in FIG. 3 may be implemented by the data pipeline system 100 of FIG.

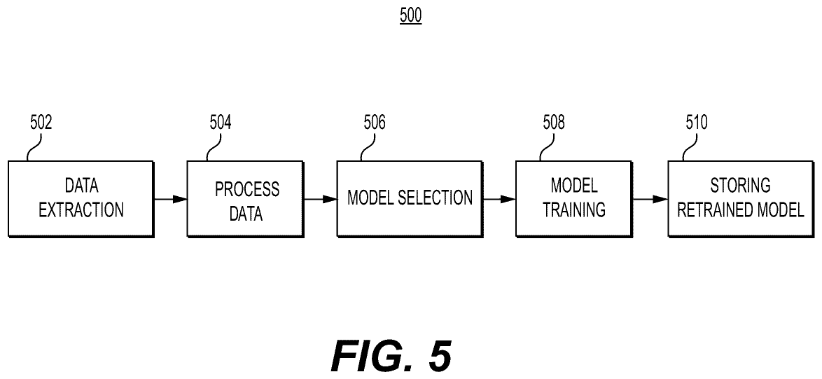

At step 302, a code push may occur. A code push may include the process of sending or transferring updates and changes made to a codebase (e.g., the host repository from step 202). For example, the code push may relate to updates a machine learning system (e.g., an artifact). This may include commits of new files, modified files, and deleted files. This may further include metadata with information related to the commit, references to identify the particular commit, and branch information. For example, step 302 may occur automatically upon the completion of a retraining model, where retraining of the model is described below in FIG. 5.

At step 304, the VCS may commit the newly received code. This may include creating a saved reference to the current state of the codebase with code push from step 302.

At step 306, the CI server (e.g., the CI server from step 204) may initiate the build process and the application may compile/be built. Step 306 may be steps 204 and 206 of FIG. 2.

At step 308, the build generated from step 306 may be tested. For example, unit testing, integration testing, system testing, end-to-end testing, performance testing, and/or security testing may be applied to test the system. At step 310 it may be determined whether the test is passed (e.g., true) or failed.

At step 312, upon determining one or more tests failed at step 310, an automated attempt at a rebuild may occur. Further, one or more alerts or notification may be sent to a separate system notifying that a new build failed.

At step 314, if the rebuild passed all tests, step 208 may occur. This may include artifact capture at artifact location, meaning the artifact file may be logged in the artifact repository. At step 316, step 210 may occur. This may include deploying the artifact files onto one or more servers to deploy the artifact to one or more users.

At step 318, the process of FIG. 3 may complete upon the application deployment of step 316.

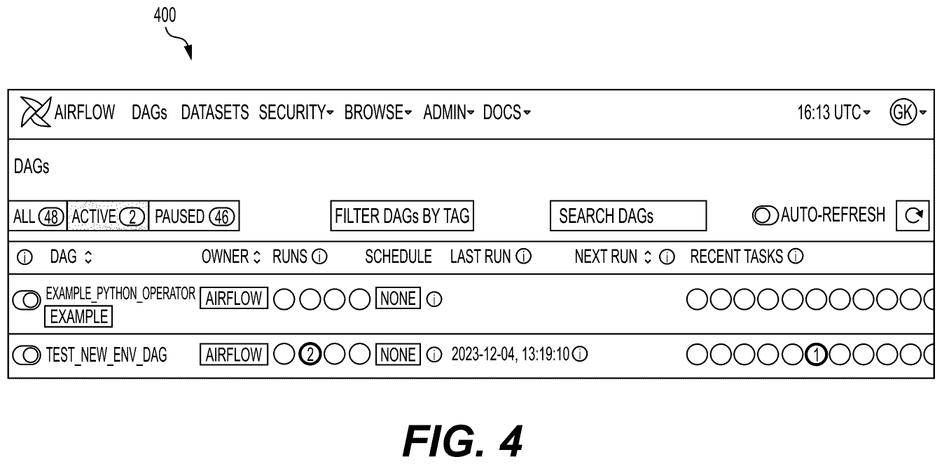

FIG. 4 depicts an exemplary user interface 400 for a model retraining pipeline, according to one or more embodiments. The system described herein may be configured to use a platform for developing, scheduling, and monitoring batch-oriented workflows. For example, the system may implement Apache Airflow Scheduler. This aspect of the system may be referred to as the Scheduler.

The Scheduler may be a platform for orchestrating complex workflows. The Scheduler's primary role may be to manage the execution of workflows by determining when to run tasks based on their dependencies and schedules. The Scheduler may periodically check the status of each tasks and launch tasks that are ready to run based on their defined schedule. The Scheduler may orchestrate the execution of workflows by managing the timing and order of the task executions.

In Airflow, a Directed Acyclic Graph (DAG) may be a collection of all the tasks a system may want to run, organized in a way that reflects their relationships and dependencies. The user interface 400 this Scheduler may display the DAG, owner, runs, schedule, last run, and/or recent tasks.

FIG. 5 depicts an exemplary flowchart 500 of a method for automatically implementing a machine learning system, according to one or more embodiments. Implementing the machine learning system may include training, or retraining a machine learning system, and in some examples applying the retrained machine learning system. In some embodiments, the process of FIG. 5 may be implemented by the Scheduler. The method described in FIG. 5 may further be implemented by the data pipeline system 100 of FIG. 1. The method of FIG. 5 may occur at set intervals for a machine learning systems or automatically upon detection of a set amount of retrieved data. The steps of the method depicted in flowchart 500 may occur automatically and without human-in-the-loop actions.

Step 502 may include extracting data from one or more data sources (e.g., data source 101 of FIG. 1). This may include receiving a plurality of data objects, the plurality of data objects corresponding to information technology event data and representing the occurrence of an event. For example, custom python scripts may pull the plurality of data objects. In some examples, the custom python scripts may pull only relevant data based on the type of machine learning system being trained. For example, if the machine learning system performs incident detection, only incident data may be pulled at this step. In some examples, data may be extracted from multiple data sources.

Step 504 may include processing the plurality of data objects (e.g., by processing platform 160 of FIG. 1). This may include removing outliers and inconsistent data from the plurality of data objects and determining appropriate corresponding metadata for missing data from the plurality of data objects. Determining the missing data may ensure the data format is compatible with the model's input requirements. At this step, feature scaling, normalization, and other transformations may be applied. Additional processing algorithms applied at this step may include applying one or more of a lower casing, tokenization, punctuation mark removal, stop word removal, stemming, and/or lemmatization algorithms.

Step 506 may include accessing or selecting a first model of a first machine learning system. The machine learning system may be configured to analyze information technology data. For example. The first machine learning system may be configured to identify historically similar incidents received by a system. The model may refer to a version of a machine learning model. For example, each time a machine learning system is retrained, each new version of the machine learning model may be saved as a model. In some examples, the first model may refer to a latest version of the first machine learning system, where the first machine learning system has previous been trained. In some examples, step 506 may be performed at set intervals or upon a set amount of relevant data (e.g., relevant data from step 502) being received.

The method may further include evaluating whether to perform hyperparameter tuning for the first model of the first machine learning system based on characteristics of the plurality of data objects. Hyperparameters may include the parameters of a machine learning model which are set prior to training and they may control aspects of the training process. Hyperparameters may include model architecture hyperparameters (e.g., number of hidden layers, number of neurons), training-related hyperparameters (e.g., learning rate, batch size, and optimizer choice), and regularization-related hyperparameters (e.g., dropout rate, L2 regularization). An exemplary hyperparameter may be the learning rate. The learning rate may refer to the parameter that controls how quickly or slowly a model's parameters are updated during training. The method may include applying a groupsearch function to find an optimal learning rate for a machine learning model. The groupsearch function may intake the plurality of data objects and the first model as input. A groupsearch function may assist with narrowing down a possible range of learning rate. For example, if a requested learning rate as set between 0.01 and 05, a groupsearch function may be applied to determine an optimal learning rate. This may include, the groupsearch function analyzing a set of learning rate values from the set between 0.01 and 0.05 and determining initial samplings of various learning rates. The samples may then be evaluated (e.g., by validation accuracy or loss). The groupsearch function may then refine the search to determine the optimal learning rate. The groupsearch function may then output one or more optimal hyperparameters such as a learn rate. This updated hyperparameter may then be updated for the first model of the first machine learning system.

In some examples, multiple techniques may be applied to determine whether to perform hyperparameter turning. The similarity of the plurality of data objects as compared to past training data objects may be analyzed. The amount of retrieved plurality of data objects may be considered. For example, if the previous training dataset is smaller than the received plurality of data objects, hyperparameter turning may be considered. Further, the plurality of data objects complexity and characteristics may be considered. If the plurality of data objects addresses new or unique circumstances, the system may proceed with hyperparameter turning. Model retraining may only proceed upon determining hyperparameter tuning would improve the machine learning system.

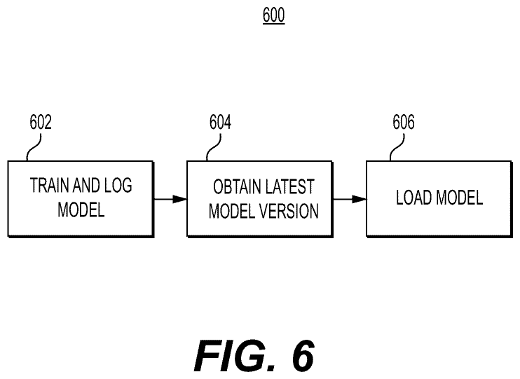

Step 508 may include training the first model of the first machine learning system based on the processed plurality of data objects to determine a retrained model. This may include inserting the processed plurality of data objects into the first model of the machine learning system, calculating a loss associated for the first model, computing gradients of the loss, and updating parameters of the first model utilizing an optimization algorithm that incorporates the gradient of the loss. For example, the loss valuables may be utilized to compute the gradients of the loss with respect to the retrained model's parameters (e.g., backpropagation). An optimization algorithm such as gradient descent or stochastic gradient descent may then be used to update the model's parameters. Training may further include comparing the performance of the retrained model with a previous model of the first machine learning system to ensure the retrained model has improved model performance as compared to the previous model. For example, the model repository may be accessed, as described in FIG. 6, to access a previous model. For example, monitoring of training metrics such as accuracy, loss, and convergence may be applied to assess model performance. The method may include fine-tuning the model by adjusting parameters (e.g., weights and biases of the model) or model architecture based on validation results. The method may further include comparing the performance of the retrained model with the original model to ensure improvement in the performance of the model. If the retrained model does not have improved performance, the retrained model may be discarded and step 510 may not occur.

Step 510 may include storing a retrained model of the first machine learning system (e.g., in the model repository 190 of FIG. 1). For example, a retrained model with versioning along with the metadata production environment may be stored. Storing a retrained model of the first machine learning system includes assigning an updated name, timestamp, and tag of the retrained model to storage. The retrained model may be stored as an artifact of the machine learning system.

For example, once an artifact is created for a machine learning model by implementing the method of FIG. 5, the process of FIG. 2 may be applied to automatically deploy the artifact of the machine learning system.

The system described herein may be configured to apply model versioning (e.g., retaining and saving versions of a model as described in FIG. 5). This may include logging different version of a machine learning model during training. The system may be configured to access and load specific versions of the model to a user in order to generate a prediction. For example, the system may utilize MLflow software to provide model repository versioning and serving.

FIG. 6 depicts a flowchart 600 of a method for model repository versioning and serving, according to one or more embodiments.

Step 602 may include training and logging a particular machine learning model (e.g., as shown in steps 502-510 of FIG. 5). In an exemplary case, the model may be trained and logged my implementing MLflow software. For example, the system may apply “mlflow.log_model” algorithm to log a model. Logging the model may associates it with a name and time (e.g., using “your_model_name_datetime”) and the run ID. This step may allow a user to organize and manage different versions of a particular model.

Step 604 may include obtaining a latest version of a model. For example, a user can load and access the latest version of the model using the model name, date, time and/or tag. This may ensure that a user is always working with the most recent version of a particular model.

Step 606 may include loading a particular model (e.g., a latest version of a model). For example, this step may provide the latest model version and ensure that the latest version of a model will be loaded. This may then ensure predict required function with the loaded model.

After the retrained model is loaded to a server, the model may be configured to generate predictions to one or more users. For example, a user access the retrained model of the machine learning system be generate a prediction. For example, the machine learning model may be configured to predict one or more similar historical incidents to a received incident.

The following steps may be followed to build a local repository (e.g., a package-management system). The local repository may, for example, be a package manager (PIP). The local repository may include the VCS as described herein (e.g., in step 202 of FIG. 2). First, at step one, the system may be configured to create a new package repository (e.g., in GitHub). Second at step two, the system may be configured to add python package files to the package repository. This may include a setup file where one may add package version details. Third, at step three, the system may be configured to install the packages and use all the methods defined in the repository package.

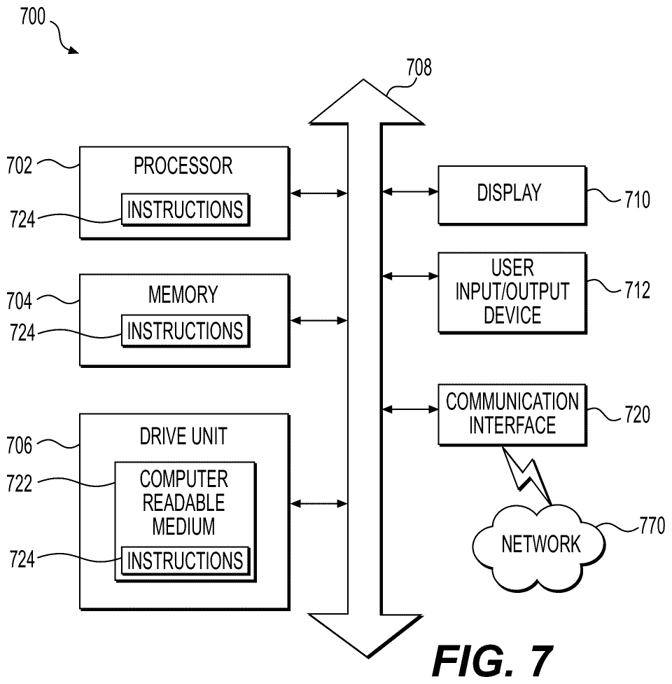

As illustrated in FIG. 7, the computer system 700 may include a processor 702, e.g., a central processing unit (CPU), a graphics processing unit (GPU), or both. The processor 702 may be a component in a variety of systems. For example, the processor 702 may be part of a standard personal computer or a workstation. The processor 702 may be one or more general processors, digital signal processors, application specific integrated circuits, field programmable gate arrays, servers, networks, digital circuits, analog circuits, combinations thereof, or other now known or later developed devices for analyzing and processing data. The processor 702 may implement a software program, such as code generated manually (i.e., programmed).

The computer system 700 may include a memory 704 that can communicate via a bus 708. The memory 704 may be a main memory, a static memory, or a dynamic memory. The memory 704 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 704 includes a cache or random-access memory for the processor 702. In alternative implementations, the memory 704 is separate from the processor 702, such as a cache memory of a processor, the system memory, or other memory. The memory 704 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 704 is operable to store instructions executable by the processor 702. The functions, acts or tasks illustrated in the figures or described herein may be performed by the programmed processor 702 executing the instructions stored in the memory 704. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 700 may further include a display 710, such as a liquid crystal display (LCD), an organic light emitting diode (OLED), a flat panel display, a solid-state display, a cathode ray tube (CRT), a projector, a printer or other now known or later developed display device for outputting determined information. The display 710 may act as an interface for the user to see the functioning of the processor 702, or specifically as an interface with the software stored in the memory 704 or in the drive unit 706.

Additionally or alternatively, the computer system 700 may include a user input/output device 712 configured to allow a user to interact with any of the components of system 700. The input/output device 712 may be a number pad, a keyboard, or a cursor control device, such as a mouse, or a joystick, touch screen display, remote control, or any other device operative to interact with the computer system 700.

The computer system 700 may also or alternatively include a disk or optical drive unit 706. The disk drive unit 706 may include a computer-readable medium 722 in which one or more sets of instructions 724, e.g., software, can be embedded. Further, the instructions 724 may embody one or more of the methods or logic as described herein. The instructions 724 may reside completely or partially within the memory 704 and/or within the processor 702 during execution by the computer system 700. The memory 704 and the processor 702 also may include computer-readable media as discussed above.

In some systems, a computer-readable medium 722 includes instructions 724 or receives and executes instructions 724 responsive to a propagated signal so that a device connected to a network 770 can communicate voice, video, audio, images, or any other data over the network 770. Further, the instructions 724 may be transmitted or received over the network 770 via a communication port or interface 720, and/or using a bus 708. The communication port or interface 720 may be a part of the processor 702 or may be a separate component. The communication port 720 may be created in software or may be a physical connection in hardware. The communication port 720 may be configured to connect with a network 770, external media, the display 710, or any other components in system 700, or combinations thereof. The connection with the network 770 may be a physical connection, such as a wired Ethernet connection or may be established wirelessly as discussed below. Likewise, the additional connections with other components of the system 700 may be physical connections or may be established wirelessly. The network 770 may alternatively be directly connected to the bus 708.

While the computer-readable medium 722 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 722 may be non-transitory, and may be tangible.

The computer-readable medium 722 can include a solid-state memory such as a memory card or other package that houses one or more non-volatile read-only memories. The computer-readable medium 722 can be a random-access memory or other volatile re-writable memory. Additionally or alternatively, the computer-readable medium 722 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 700 may be connected to one or more networks 770. The network 770 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 770 may include wide area networks (WAN), such as the Internet, local area networks (LAN), campus area networks, metropolitan area networks, a direct connection such as through a Universal Serial Bus (USB) port, or any other networks that may allow for data communication. The network 770 may be configured to couple one computing device to another computing device to enable communication of data between the devices. The network 770 may generally be enabled to employ any form of machine-readable media for communicating information from one device to another. The network 770 may include communication methods by which information may travel between computing devices. The network 770 may be divided into sub-networks. The sub-networks may allow access to all of the other components connected thereto or the sub-networks may restrict access between the components. The network 770 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for automatically implementing a machine learning system, the method comprising:
receiving a plurality of data objects, the plurality of data objects corresponding to information technology event data and representing an occurrence of an event;
processing the plurality of data objects;
evaluating whether to perform hyperparameter tuning of a first model of a first machine learning system based on characteristics of the plurality of data objects;
training the first model of the first machine learning system based on the processed plurality of data objects to determine a retrained model, wherein the training the first model further includes:
comparing performance of the retrained model with a previous model of the first machine learning system to ensure the retrained model has improved model performance as compared to the previous model; and
storing the retrained model of the first machine learning system.

2. The method of claim 1, wherein the plurality of data objects is received from a plurality of data sources.

3. The method of claim 1, wherein the processing the plurality of data objects further includes:
applying one or more of a lower casing, tokenization, punctuation mark removal, stop word removal, stemming, and/or lemmatization algorithms.

4. The method of claim 1, wherein the processing the plurality of data objects further includes:
removing outlier and inconsistent data from the plurality of data objects; and
determining corresponding metadata for missing data from the plurality of data objects, wherein the corresponding metadata ensures the plurality of data objects have a compatible format with first model input requirements.

5. The method of claim 1, wherein the machine learning system is configured to analyze information technology data.

6. The method of claim 1, wherein the first model of the first machine learning system corresponds to a latest version of the first machine learning system, the first machine learning system having previously been trained.

7. The method of claim 1, wherein the evaluating whether to perform hyperparameter tuning based on characteristics of the plurality of data objects, further includes:
applying a groupsearch function to optimize one or more hyperparameters of the first model, wherein the one or more hyperparameters includes a learning rate.

8. The method of claim 1, wherein the training the first model of the first machine learning system further includes:
inserting the processed plurality of data objects into the first model of the machine learning system;
calculating a loss associated for the first model;
computing gradients of the loss; and
updating parameters of the first model utilizing an optimization algorithm that incorporates the gradient of the loss.

9. The method of claim 1, wherein the storing the retrained model of the first machine learning system includes assigning an updated name, timestamp, and tag of the retrained model to storage.

10. The method of claim 1, further including:
accessing the retrained model; and
utilizing the retrained model to process information technology event data to identify correlation, similarity, or a root cause an information technology event.

11. A computer-implemented system for automatically implementing a machine learning system, the system comprising:
a memory having processor-readable instructions stored therein; and
at least one processor configured to access the memory and execute the processor-readable instructions to perform operations including:
receiving a plurality of data objects, the plurality of data objects corresponding to information technology event data and representing an occurrence of an event;
processing the plurality of data objects;
evaluating whether to perform hyperparameter tuning of a first model of a first machine learning system based on characteristics of the plurality of data objects;
training the first model of the first machine learning system based on the processed plurality of data objects to determine a retrained model, wherein the training the first model further includes:
comparing performance of the retrained model with a previous model of the first machine learning system to ensure the retrained model has improved model performance as compared to the previous model; and
storing the retrained model of the first machine learning system.

12. The system of claim 11, wherein the plurality of data objects is received from a plurality of data sources.

13. The system of claim 11, wherein the processing the plurality of data objects further includes:
applying one or more of a lower casing, tokenization, punctuation mark removal, stop word removal, stemming, and/or lemmatization algorithms.

14. The system of claim 11, wherein the processing the plurality of data objects further includes:
removing outlier and inconsistent data from the plurality of data objects; and
determining corresponding metadata for missing data from the plurality of data objects, wherein the corresponding metadata ensures the plurality of data objects have a compatible format with first model input requirements.

15. The system of claim 11, wherein the machine learning system is configured to analyze information technology data.

16. The system of claim 11, wherein the first model corresponds to a latest version of the first machine learning system, the first machine learning system having previously been trained.

17. A non-transitory computer readable medium configured to store processor-readable instructions which, when executed by at least one processor, cause the at least one processor to perform operations including:
receiving a plurality of data objects, the plurality of data objects corresponding to information technology event data and representing an occurrence of an event;
processing the plurality of data objects;
evaluating whether to perform hyperparameter tuning of a first model of a first machine learning system based on characteristics of the plurality of data objects;
training the first model of the first machine learning system based on the processed plurality of data objects to determine a retrained model, wherein training the first model further includes:
comparing performance of the retrained model with a previous model of the first machine learning system to ensure the retrained model has improved model performance as compared to the previous model; and
storing the retrained model of the first machine learning system.

18. The non-transitory computer readable medium of claim 17, wherein the plurality of data objects is received from a plurality of data sources.

19. The non-transitory computer readable medium of claim 17, wherein the processing the plurality of data objects further includes:
applying one or more of a lower casing, tokenization, punctuation mark removal, stop word removal, stemming, and/or lemmatization algorithms.

20. The non-transitory computer readable medium of claim 17, wherein the processing the plurality of data objects further includes:
removing outlier and inconsistent data from the plurality of data objects; and
determining corresponding metadata for missing data from the plurality of data objects, wherein the corresponding metadata ensures the plurality of data objects have a compatible format with first model input requirements.
